(19) United States
(12) Patent Application Publication
(10) Pub. No.: US 2017/0279981 A1
(43) Pub. Date: Sep. 28, 2017

(54) NON-TRANSITORY COMPUTER READABLE MEDIUM STORING COMMUNICATION PROGRAM, COMMUNICATION DEVICE AND COMMUNICATION METHOD

(71) Applicant: FUJI XEROX CO., LTD., Tokyo (JP)

(72) Inventor: Akiko Mochizuki, Kanagawa (JP)

(21) Appl. No.: 15/207,811

(22) Filed: Jul. 12, 2016

(30) Foreign Application Priority Data
Mar. 22, 2016 (JP) 2016-057020

(51) Int. Cl. H04N 1/00; H04N 1/32

(52) U.S. Cl. CPC H04N 1/00244; H04N 1/32; H04N 2201/0094

(57) ABSTRACT

A non-transitory computer readable medium storing a communication program causes a computer to perform a process including: receiving first information transmitted at a time when an external communication device communicates with a target communication device; generating second information which is to be transmitted to the target communication device by an own device; and correcting the second information which is to be transmitted to the target communication device at a time when the own device communicates with the target communication device, based on a difference between the first information and the second information.

### CROSS-REFERENCE TO RELATED APPLICATION

This application is based on and claims priority under 35 USC 119 from Japanese Patent Application No. 2016-057020 filed on Mar. 22, 2016.

### BACKGROUND

### (i) Technical Field

The present inventions relates to a non-transitory computer readable medium storing a communication program, a communication device, and a communication method.

### SUMMARY

According to one aspect of the present invention, a non-transitory computer readable medium storing a communication program causes a computer to perform a process including: receiving first information transmitted at a time when an external communication device communicates with a target communication device; generating second information which is to be transmitted to the target communication device by an own device; and correcting the second information which is to be transmitted to the target communication device at a time when the own device communicates with the target communication device, based on a difference between the first information and the second information.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a schematic diagram illustrating an example of a configuration of a communication system according to an exemplary embodiment;

FIG. 2 is a block diagram illustrating a configuration example of a communication device according to the exemplary embodiment;

FIG. 3 is a schematic diagram illustrating an example of a configuration of a received packet;

FIG. 4 is a schematic diagram illustrating an example of a configuration of a generated packet;

FIG. 5 is a flowchart illustrating an example of an operation of a communication device;

FIG. 6 is a schematic diagram illustrating another example of the configuration of the received packet;

FIG. 7 is a schematic diagram illustrating another example of the configuration of the generated packet;

FIG. 8 is a schematic diagram illustrating an example of a configuration of a response packet;

FIG. 9 is a schematic diagram illustrating another example of the configuration of the received packet; and

FIG. 10 is a schematic diagram illustrating another example of the configuration of the generated packet.

### DETAILED DESCRIPTION

### Exemplary Embodiment

### Configuration of Communication System

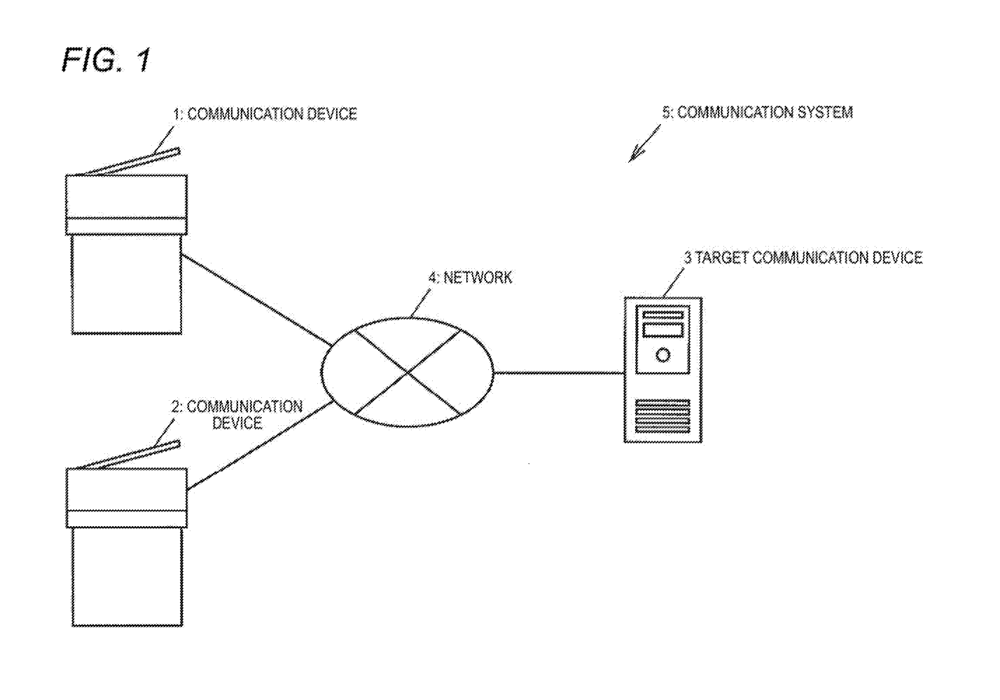

FIG. 1 is a schematic diagram illustrating an example of a configuration of a communication system according to an exemplary embodiment.

A communication system 5 has a configuration in which a communication device 1, a communication device 2, and a target communication device 3 are connected to each other through a network 4, so as to enable communication with each other.

As an example, the communication device 1 may be a multifunction machine which has functions of printing, scanning, FAX, and the like, and be a communication device communicating with the target communication device 3 in order to perform the functions. The communication device 1 includes an electronic component such as a central processing unit (CPU) and a flash memory having a function of processing information, in a main body.

Similarly to the communication device 1, as an example, the communication device 2 is a multifunction machine which has functions of printing, scanning, FAX, and the like, and is a communication device communicating with the target communication device 3 in order to perform the functions. It is not necessary that the communication device 2 has completely the same configuration as the communication device 1. In the exemplary embodiment, the communication device 2 is assumed to be a product different from the communication device 1.

The target communication device 3 is a device such as a server, which has a communication function. The target communication device 3 includes an electronic component such as a central processing unit (CPU) and a flash memory having a function of processing information, in the main body.

The network 4 is a communication network which allows high-speed communication. For example, the network 4 is a wired or wireless communication network such as an intranet and a local area network (LAN).

The communication device 1 and the communication device 2 are set to generate image information by scanning an original document using so-called “Scan to SMB”, and to transmit the generated image information to a shared folder which is formed in a memory of the target communication device 3, through the network 4. It is assumed that errors such as authentication failure or character corruption occur between the communication device 1 and the target communication device 3 and errors do not occur between the communication device 2 and the target communication device 3. On the above assumption, the communication device 1 refers to communication between the communication device 2 and the target communication device 3 and attempts to address an error occurring between the communication device 1 and the target communication device 3.

A above term “communication setting” indicates not a setting item, which is automatically set by transmission and reception between the communication device 1 and the target communication device 3, on a communication protocol, but an item which is not automatically set.

### Configuration of Communication Device

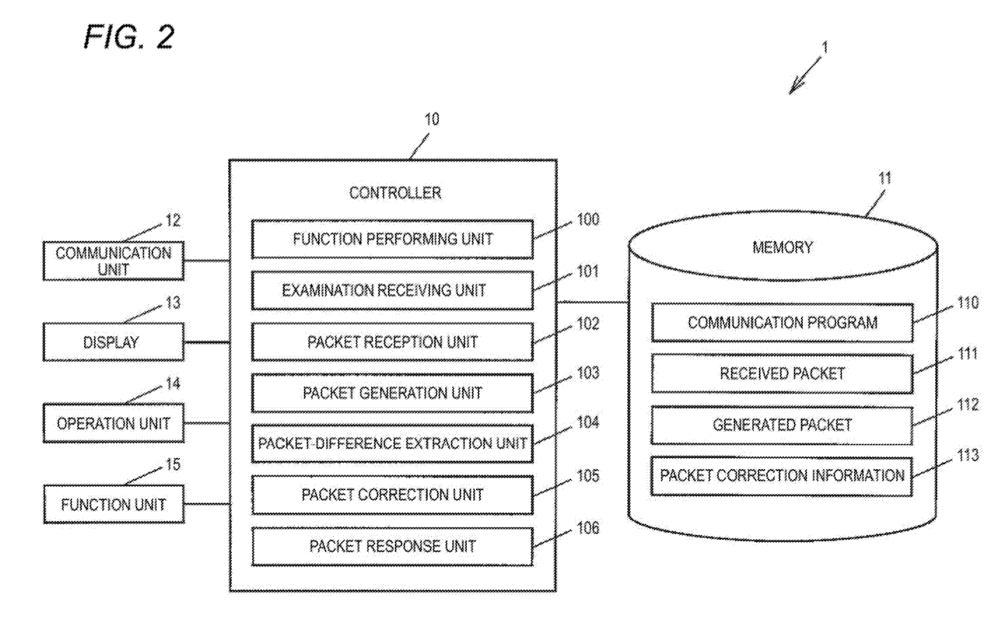

FIG. 2 is a block diagram illustrating a configuration example of the communication device 1 according to the exemplary embodiment.

The communication device 1 includes a controller 10, a memory 11, a communication unit 12, a display 13, an operation unit 14, and a function unit 15. The controller 10 is configured from a CPU, etc., like and controls the units and executes various programs. The memory 11 is configured from a recording medium such as a flash memory, and stores information. The communication unit 12 performs communication with an external device through a network. The display 13 is configured from a liquid crystal display (LCD) and the like, and displays a letter or an image. The operation unit 14 is configured from a button, a touchpad, and the like, and receives an input operation. The function unit 15 performs functions of printing, scanning, FAX, and the like.

The controller 10 executes a communication program 110 (which will be described later) so as to perform functions as a function performing unit 100, an examination receiving unit 101, a packet reception unit 102, a packet generation unit 103, a packet-difference extraction unit 104, a packet correction unit 105, and a packet response unit 106.

The function performing unit 100 causes the function unit 15 to perform a function of printing, scanning, FAX, or the like. “Scan to SMB” as an example of the function is performed by the function performing unit 100, and communication is performed through the communication unit 12.

In a case where the function unit 15 performs the function of “Scan to SMB”, and an error occurs, the examination receiving unit 101 displays an image or characters for confirming whether or not examination is performed, in the display 13. The examination receiving unit 101 receives an examination request of a user through the operation unit 14. When the examination receiving unit 101 receives the examination request, the examination receiving unit 101 causes the communication device 1 to be switched to an examination mode. The examination receiving unit 101 causes the function unit 15 to activate a SMB server mode, in addition to an SMB client mode which is being activated. Thus, the examination receiving unit 101 sets the packet reception unit 102 (which will be described below) to allow reception of a packet from the communication device 2 through the network 4.

The packet reception unit 102 receives a packet from the communication device 2 through the network 4, and stores the received packet as a received packet 111 in the memory 11. A user performs a connection from the communication device 2 to the communication device 1 on an SMB protocol, and thus the received packet 111 is received. In a case where an address of the target communication device 3 as an SMB server is preset in the communication device 2, an address is changed from the address of the communication device 3 to the address of the communication device 1, and then the packet reception is performed.

The packet generation unit 103 generates a packet which is to be transmitted when the communication device 1 is connected to the target communication device 3 which is an SMB server. The packet generation unit 103 stores the generated packet as a generated packet 112 in the memory 11. At this time, loopback communication may be performed in such a manner that the generated packet 112 is transmitted to the communication device 1 itself, the packet reception unit 102 receives the generated packet 112, and the generated packet 112 is stored.

The packet-difference extraction unit 104 compares the received packet 111 and the generated packet 112, and extracts a difference between the received packet 111 and the generated packet 112. The packet-difference extraction unit 104 forms, based on the extracted difference, a packet correction filter to be used for correcting the generated packet 112 which is generated by the packet generation unit 103, so as to have the same details as those of the received packet 111, and the packet-difference extraction unit 104 stores the formed packet correction filter as packet correction information 113 in the memory 11.

The packet correction unit 105 corrects a packet which is generated for communication with the target communication device 3 by the function performing unit 100, based on the packet correction information 113, and the packet correction unit 105 transmits the corrected packet to the target communication device 3 through the communication unit 12.

In a case where extraction of the difference from a received packet 111, which is received by the packet-difference extraction unit 104 for the first time, and a generated packet 112, which is generated for the first time, is not possible, the packet response unit 106 performs a response by generating a response packet as a response to the received packet 111 and transmits the generated response packet to the communication device 2.

Then, the packet reception unit 102 receives a packet as a response to the response packet, from the communication device 2 and stores the received packet as a new received packet 111, in the memory 11. The packet generation unit 103 generates a packet as a response to the response packet and stores the generated packet as a new generated packet 112, in the memory 11.

The memory 11 stores: the communication program 110 for operating the controller 10 to function the above-described units 100 to 106; the received packet 111; the generated packet 112; the packet correction information 113, and the like.

Operation of Communication Device

Next, an action of the exemplary embodiment will be described.

Firstly, if the operation unit 14 receives an operation, the function performing unit 100 causes the function unit 15 to perform “Scan to SMB”. The function unit 15 scans an original document so as to generate image information. The function unit 15 communicates with the target communication device 3 in order to transmit the generated image information to the shared folder of the target communication device 3.

The function unit 15 performs communication with the target communication device 3. However, it is assumed that an error in the communication may occur. It is assumed that an error does not occur between the communication device 2 and the target communication device 3.

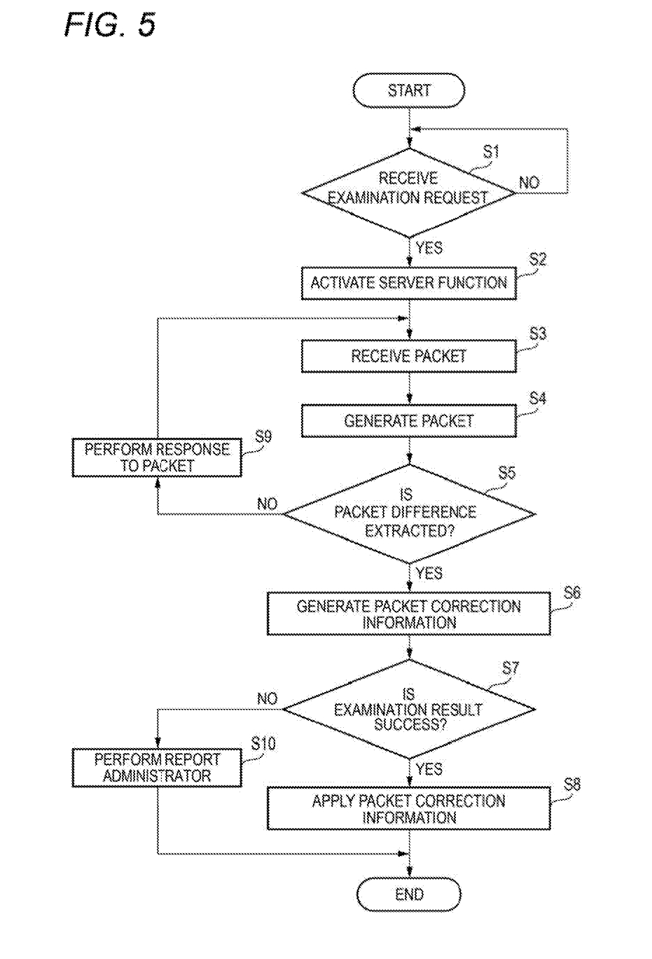

FIG. 5 is a flowchart illustrating an example of an operation of the communication device 1.

Firstly, in a case where the function unit 15 performs the function of “Scan to SMB” and then an error occurs, the examination receiving unit 10 control the display 13 to display an image or characters for confirming whether or not examination is performed and receives an examination request of a user through the operation unit 14 (S1).

Then, in a case where the examination receiving unit 101 receives the examination request (S1, Yes), the examination receiving unit 101 causes the communication device 1 to be switched to the examination mode and causes the function unit 15 to activate the SMB server mode, in addition to the SMB client mode which is being activated (S2). As activating the SMB server mode, the packet reception unit 102 becomes a state of enabling reception of a packet from the communication device 2 through the network 4.

Then, a user performs a connection from the communication device 2 to the communication device 1 on the SMB protocol. In a case where an address of the target communication device 3 as an SMB server is preset in the communication device 2, an address is changed from the address of the communication device 3 to the address of the communication device 1, and then the packet reception is performed.

The packet reception unit 102 receives a packet from the communication device 2 through the network 4, and stores the received packet as a received packet 111 in the memory 11 (S3).

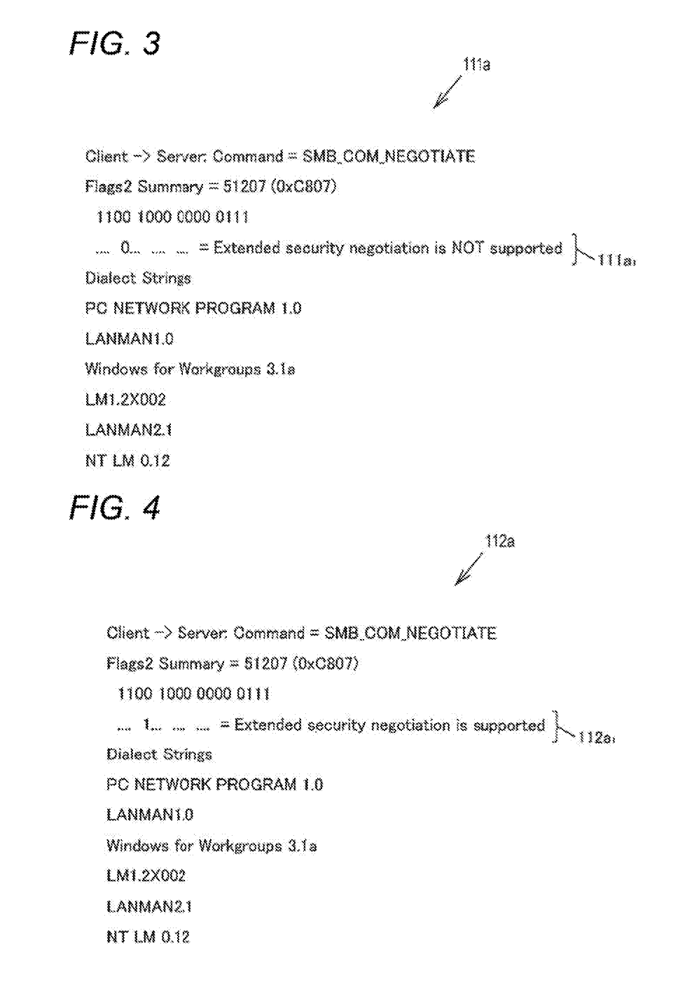

FIG. 3 is a schematic diagram illustrating an example of a configuration of the received packet 111.

A received packet 111a is an example of the received packet 111. In the received packet 111a, “Extended security” is set to “ . . . 0 . . . ”, and one of flags is not raised.

The packet generation unit 103 generates a packet which is to be transmitted when the communication device 1 is connected to the target communication device 3 being an SMB server, and stores the generated packet as a generated packet 112 in the memory 11 (S4).

FIG. 4 is a schematic diagram illustrating an example of a configuration of the generated packet 112.

A generated packet 112a is an example of the generated packet 112. In the generated packet 112a, “Extended security” is set to “ . . . 1 . . . ”, and one of the flags is raised.

The packet-difference extraction unit 104 compares the received packet 111a and the generated packet 112a, and extracts a difference between the received packet 111a and the generated packet 112a (S5). That is, the difference corresponds whether or not one of the flags of “Extended security” is raised.

In a case where the difference is extracted in Step S5 (S5, Yes), the packet-difference extraction unit 104 forms, based on the extracted difference, a packet correction filter for correcting the generated packet 112a which is generated by the packet generation unit 103, so as to have the same details as those of the received packet 111a (S6), and then the formed packet correction filter as packet correction information 113 is stored, in association with the address of the target communication device 3 in the memory 11. That is, a packet correction filter for changing one of the flags so as to cause “ . . . 1 . . . ” of “Extended security” in the generated packet 112 to be changed to “ . . . 0 . . . ” is made as the packet correction information 113.

Then, the packet correction unit 105 corrects (recompiles) a packet which is generated for communication with the target communication device 3 by the function performing unit 100, based on the packet correction information 113, transmits the corrected packet to the target communication device 3 through the communication unit 12. If an error in communication does not occur, the packet correction unit 105 determines that the examination result is a success (S7, Yes), and applies the packet correction information 113 in the subsequent communication (S8). Information regarding the extracted difference or information of the generated correction filter may be reported to a administrator.

In a case where an error in communication occurs, the packet correction unit 105 determines that the examination result is a failure in Step S7, the packet correction unit 105 reports a message indicating the occurrence of a communication error, to an external terminal used by a administrator through the communication unit 12 (S10). Even in a case where the examination result is determined to be a success, the packet correction unit 105 may report a message indicating the success of the communication based on the packet correction information 113.

A case where the received packet 111 and the generated packet 112 are compared to each other, and extraction of the difference is not possible in Step S5 (S5, No) will be described.

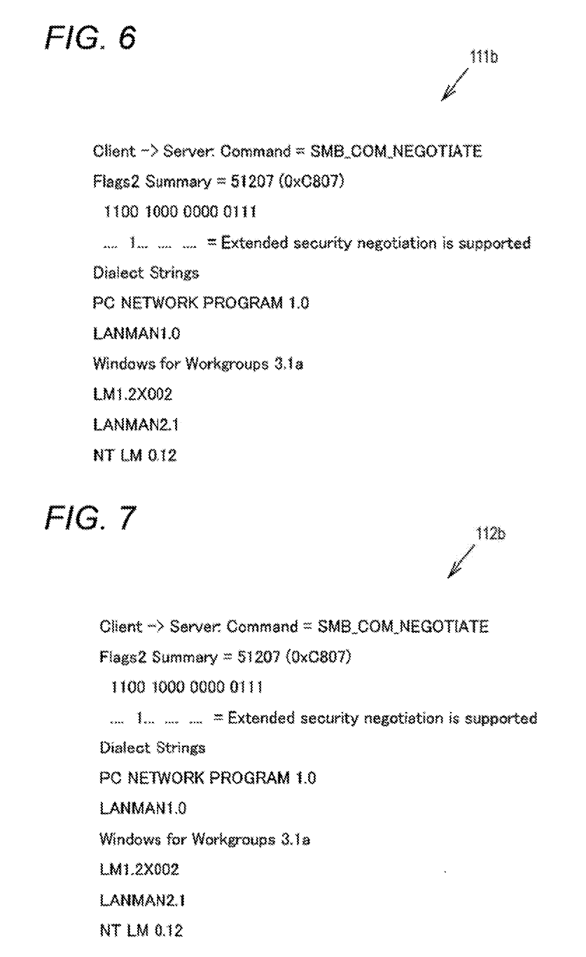

FIG. 6 is a schematic diagram illustrating another example of the configuration of the received packet 111.

A received packet 111b is an example of the received packet 111. In the received packet 111b, “Extended security” is set to “ . . . 1 . . . ”, and one of the flags is raised.

FIG. 7 is a schematic diagram illustrating another example of the configuration of the generated packet 112.

A generated packet 112b is an example of the generated packet 112. In the generated packet 112b, “Extended security” is set to “ . . . 1 . . . ”, and one of the flags is raised similarly. That is, the flags of “Extended security” do not have a difference, and there is no difference at other locations in the generated packet 112b.

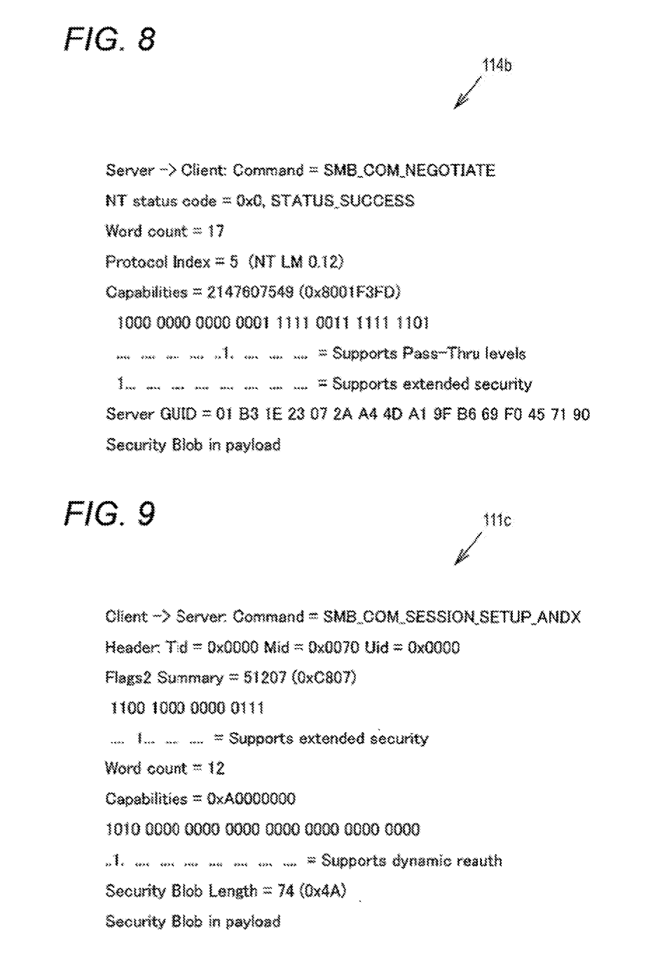

FIG. 8 is a schematic diagram illustrating an example of a configuration of the response packet.

In this case, the packet response unit 106 performs a response in such a manner that the packet response unit 106 generates a response packet 114b as a response to the received packet 111b, and transmits the generated response packet 114b to the communication device 2 (S9).

After that, the packet reception unit 102 receives a packet as a response to the response packet 114b, from the communication device 2, and stores the received packet as a new received packet 111, in the memory 11 (S3). The packet generation unit 103 generates a packet as a response to the response packet, and stores the generated packet as a new generated packet 112, in the memory 11 (S4).

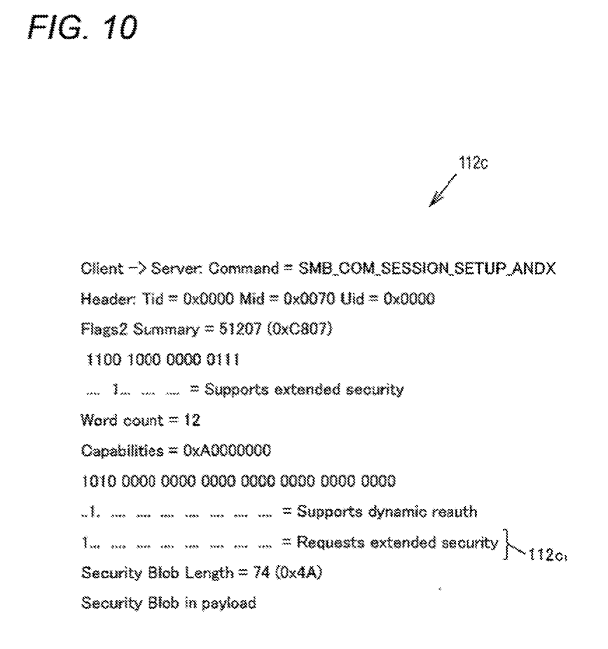

FIG. 9 is a schematic diagram illustrating another example of the configuration of the received packet 111. FIG. 10 is a schematic diagram illustrating another example of the configuration of the generated packet 112.

Regarding a difference between a received packet 111c and a generated packet 112c, a flag of “Requests extended security” 112c₁ of the generated packet 112 is provided in the generated packet 112c, but is not provided in the received packet 111c.

Accordingly, the packet-difference extraction unit 104 sets a packet correction filter for removing the flag of “Requests extended security” 112c₁ of the generated packet 112c, as the packet correction information 113.

### Advantages of Exemplary Embodiment

According to the above-described exemplary embodiment, a packet, which has been transmitted to the target communication device 3 from the communication devsce 2, in which an error does not occur in communication with the target communication device 3, is received as the received packet 111. Then, the received packet 111 is compared the generated packet 112 generated in the own device 2, and the correction filter is generated based on the difference between the received packet 111 and the generated packet 112. Thus, it is possible to address an error occurring in the communication device 2 in communication between the own device and the target communication device 3, without a report to an administrator. That is, it is not required that a packet or a log is transferred outwardly and analyzed.

Since a packet is corrected by using the correction filter, the correction of the software of operating the function unit is not required. In addition, since the correction filter is registered in association with the address of the target communication device 3, and the correction filter is not applied to a packet which is transmitted to other target communication devices in which a problem does not occur, it is possible to handle an error occurring between the communication device 2 and the target communication device 3, without an influence on communication between the communication device 2 and another target communication device in which a problem does not occur.

If information regarding the extracted difference or information of the generated correction filter is reported to an administrator, it is possible to cause the administrator to confirm whether there is no problem in details of the correction filter or to be helpful when upcoming firmware is improved.

### Other Exemplary Embodiments

The present invention is not limited to the aforementioned exemplary embodiment, and various modifications can be made in a range without departing from the gist of the present invention. For example, in a case of a protocol in which communication is performed by using a user datagram protocol (UDP) multicast, a multicast packet which is transmitted and received between the communication device 2 and the target communication device 3 may be acquired and the acquired packet may be compared to a packet of the own device, without the communication device 1 having a server function.

A packet capturing function may be provided in the communication device 1, and a packet which is transmitted and received between the communication device 2 and the target communication device 3 may be captured.

In a case where other communication devices which have the same type and are connected to the same network 4 are provided, the packet correction information 113 may be shared with the other communication devices. Thus, it is possible to address communication errors occurring with the target communication device 3 without the other communication devices performing a generation operation of the packet correction information 113.

The functions of the units 100 to 106 of the controller 10 are realized by a program in the aforementioned exemplary embodiment. However, all or some of the units may be realized by hardware such as ASIC. The program used in the aforementioned exemplary embodiment may be stored in a recording medium such as a CD-ROM and be provided. The operating described in the aforementioned exemplary embodiment may be replaced, deleted, and added in the range without changing the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A non-transitory computer readable medium storing a communication program causing a communication device to perform a process of communication between the communication device and a target communication device, the process comprising:
receiving a first packet at the communication device transmitted from an external communication device to the target communication device in a case where a communication error occurs in the communication between the communication device and the target communication device;
generating a second packet which is to be transmitted to the target communication device by the communication device;
correcting the second packet based on a difference between the first packet and the second packet; and
transmitting the corrected second packet to the target communication device to perform communication between the communication device and the target communication device.

2. The non-transitory computer readable medium according to claim 1, the process further comprising:
performing a response by transmitting a third packet corresponding to the first packet, to the external communication device in a case where there is no difference between the first packet and the second information packet,
receiving a new first packet which is transmitted in response to the third packet by the external communication device,
generating a new second packet which is to be transmitted in response to the third packet by the communication device, and
correcting a packet which is to be transmitted to the target communication device at a time when the communication device communicates with the target communication device, based on a difference between the new first packet and the new second packet.

3. A communication device, comprising:
a reception unit that receives a first packet transmitted from an external communication device to a target communication device in a case where a communication error occurs in the communication between the communication device and the target communication device;
a generation unit that generates a second packet which is to be transmitted to the target communication device by the communication device;
a correction unit that corrects the second packet based on a difference between the first packet and the second packet; and
a communication unit that transmits the corrected second packet to the target communication device to perform communication between the communication device and the target communication device.

4. A communication method performed by a communication device, wherein the communication device communicates with a target communication device, the method comprising:
receiving a first packet at the communication device transmitted from an external communication device to the target communication device in a case where a communication error occurs in the communication between the communication device and the target communication device;
generating a second packet which is to be transmitted to the target communication device by the communication device;
correcting the second packet based on a difference between the first packet and the second packet; and
transmitting the corrected second packet to the target communication device to perform communication between the communication device and the target communication device.
